(19) United States
(12) Patent Application Publication
(10) Pub. No.: US 2025/0376769 A1
(43) Pub. Date: Dec. 11, 2025

(54) PRODUCTION APPARATUS FOR PRODUCING ENAMELED COPPER WIRE AND METHOD FOR PRODUCING THE SAME

(71) Applicant: Proterial, Ltd., Tokyo (JP)

(72) Inventors: Takami USHIWATA, Tokyo (JP); Hajime NISHI, Tokyo (JP); Akira SETOGAWA, Tokyo (JP)

(21) Appl. No.: 19/073,853

(22) Filed: Mar. 7, 2025

(30) Foreign Application Priority Data
Jun. 11, 2024 (JP) 2024-094476

(51) Int. Cl. C23D 11/00; C23D 5/02

(52) U.S. Cl. CPC C23D 11/00; C23D 5/02

(57) ABSTRACT

Provided is a production apparatus for producing an enameled copper wire, the production apparatus comprising: a first paint applicator; a first die; a second paint applicator; a second die: and a baking section.

### CROSS-REFERENCE TO RELATED APPLICATIONS

This application claims the benefit of Japanese Patent Application No. 2024-094476 filed on Jun. 11, 2024 with the Japan Patent Office, the entire disclosure of which is incorporated herein by reference.

### BACKGROUND

The present disclosure relates to a production apparatus for producing an enameled copper wire and a method for producing an enameled copper wire.

The enameled copper wire includes a conductor, and an enamel coating. The conductor mainly comprises copper. The enamel coating covers a surface of the conductor. Japanese Unexamined Patent Application Publication No. 2019-003913 discloses a method for producing an enameled copper wire. In the method for producing an enameled copper wire, an enamel paint is applied on the surface of the conductor to form a paint film. A baking process is subsequently carried out and the enamel coating is thus formed.

### SUMMARY

A painting die is used to apply an enamel paint on a surface of a conductor. There is a case where a foreign matter gets caught in the painting die. In such a case, the foreign matter caught in the painting die may cause an abnormality in appearance of the enameled copper wire.

A cause of the appearance abnormality is as follows. When the foreign matter gets caught in the painting die, the center of the conductor deviates from the center of a hole of the painting die. In such a case, a gap between an inner surface of the painting die and the surface of the conductor (hereinafter, to be referred to as a “paint gap”) becomes non-uniform. Accordingly, a thickness of the paint film also becomes non-uniform. In an area where the paint film is thick, vaporization of a solvent in the enamel paint is hindered, and foaming occurs, whereby the appearance abnormality is caused.

In one aspect of the present disclosure, it is preferable to provide a production apparatus and a method for producing an enameled copper wire, through which occurrence of abnormality in appearance of the enameled copper wire can be suppressed.

One aspect of the present disclosure is a production apparatus for producing an enameled copper wire, the production apparatus comprising: a first paint applicator configured to apply a first paint on a surface of a conductor traveling along a travel path; a first die configured to allow the conductor with the first paint applied by the first paint applicator to pass therethrough; a second paint applicator configured to apply a second paint on the surface of the conductor, the conductor having passed through the first die and having the first paint thereon uncured; a second die configured to allow the conductor applied by the second paint applicator with the second paint to pass therethrough; and a baking section configured to bake the conductor having passed through the second die.

The apparatus for producing an enameled copper wire in one aspect of the present disclosure makes it possible to suppress occurrence of an abnormality in appearance of a produced enameled copper wire.

Another aspect of the present disclosure is a method for producing an enameled copper wire, the method comprising the steps of: applying a first paint on a surface of a conductor traveling along a travel path; allowing the conductor applied with the first paint to pass through a first die; applying a second paint on the surface of the conductor that has passed through the first die and has the first paint thereon uncured; allowing the conductor applied with the second paint to pass through a second die; and baking the conductor having passed through the second die.

The method for producing an enameled copper wire according to another aspect of the present disclosure makes it possible to suppress occurrence of an abnormality in appearance of a produced enameled copper wire.

### BRIEF DESCRIPTION OF THE DRAWINGS

Hereinafter, example embodiments of the present disclosure will be described by way of examples with reference to the accompanying drawings, in which:

FIG. 1 is an explanatory diagram of a structure of a production apparatus for producing a flat enameled copper wire;

FIG. 2 is a sectional view showing a cross-sectional shape of a flat copper wire;

FIG. 3 is a sectional view showing a cross-sectional shape of a flat copper wire stock;

FIG. 4 is a plan view of structures of a paint applicator and a baking furnace;

FIG. 5 is an explanatory diagram of the flat copper wire stock traveling a first path P1;

FIG. 6 is an explanatory diagram of the flat copper wire stock traveling a j-th path Pj, wherein “j” is any natural number greater than or equal to 2 and less than or equal to N;

FIG. 7 is a perspective view of a structure of a first die that is dividable;

FIG. 8 is a front view of the structure of the dividable first die; and

FIG. 9 is a sectional view taken along the like IX-IX in FIG. 8.

### DETAILED DESCRIPTION OF EXEMPLARY EMBODIMENTS

### First Embodiment

### 1. Overview of Method for Producing Flat Enameled Copper Wire

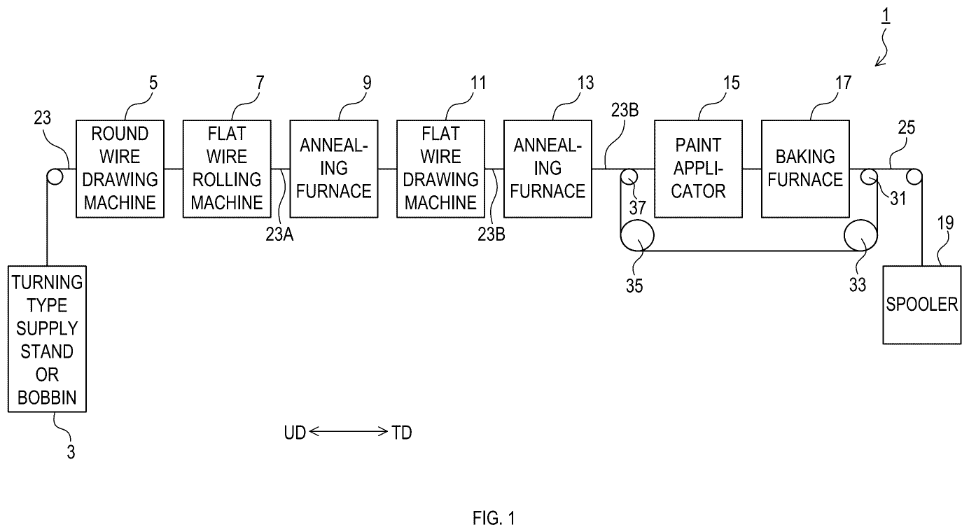

Descriptions will be given of an overview of a method for producing a flat enameled copper wire with reference to FIGS. 1 to 3. The flat enameled copper wire corresponds to an enameled copper wire. In the method for producing a flat enameled copper wire, a production apparatus 1 for producing a flat enameled copper wire shown in FIG. 1 is used. The production apparatus 1 comprises: a turning type supply stand or bobbin 3; a round wire drawing machine 5; a flat wire rolling machine 7; an annealing furnace 9; a flat wire drawing machine 11; an annealing furnace 13; a paint applicator 15; a baking furnace 17; and a spooler 19. The baking furnace 17 corresponds to a baking section.

A conductor 23 in a wire form is wound around the turning type supply stand or bobbin 3. The conductor 23 is pulled out from the turning type supply stand or bobbin 3 and travels along a travel path through the round wire drawing machine 5, the flat wire rolling machine 7, the annealing furnace 9, the flat wire drawing machine 11, the annealing furnace 13, the paint applicator 15, and the baking furnace 17 in this order and then is wound onto the spooler 19. However, a later-described flat copper wire stock 23B, which is the conductor 23 having undergone a process, passes through a section including the paint applicator 15 and the baking furnace 17 two or more times.

The conductor 23 is made from copper or copper alloy. The conductor 23 before undergoing a flat rolling process described later has a circular cross-sectional shape. The cross-section of the conductor 23 is a section perpendicular to a longitudinal direction of the conductor 23.

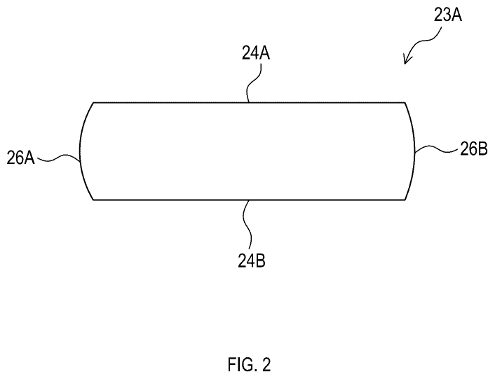

The round wire drawing machine 5 draws the conductor 23 having a circular cross-sectional shape. The flat wire rolling machine 7 carries out a flat rolling process on the traveling conductor 23. The conductor 23 having undergone the flat rolling process is referred to as a flat copper wire 23A. As shown in FIG. 2, a cross-sectional shape of the flat copper wire 23A is composed of two sides 24A, 24B, which are parallel to each other, and two arc-shaped end faces 26A, 26B. In a transverse cross section, shapes of the sides 24A, 24B are straight lines. In the transverse cross section, the sides 24A, 24B have lengths longer than lengths of the end faces 26A, 26B. The flat copper wire 23A is annealed in the annealing furnace 9.

The flat wire drawing machine 11 carries out a flat wire drawing process on the traveling flat copper wire 23A. The flat wire drawing process is a process in which a cold wire drawing process is continuously carried out on the flat copper wire 23A with the use of a flat wire drawing die. The conductor 23 having undergone the flat wire drawing process is referred to as the flat copper wire stock 23B.

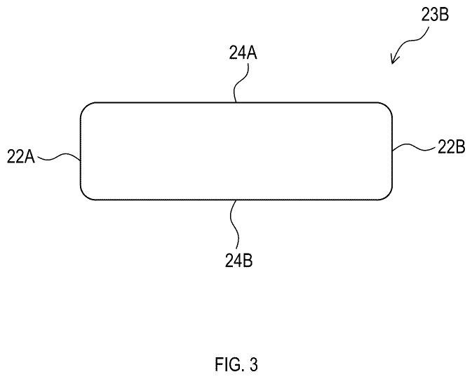

As shown in FIG. 3, the flat copper wire stock 23B has a cross section in the shape of a rounded rectangle (i.e. a rectangle having rounded corners). Long sides of the rounded rectangle are the sides 24A, 24B. Short sides 22A, 22B of the rounded rectangle are originated from the end faces 26A, 26B of the flat copper wire 23A.

In the annealing furnace 13, the flat copper wire stock 23B is annealed. The paint applicator 15 applies an enamel paint on a surface of the flat copper wire stock 23B while the flat copper wire stock 23B is traveling along a travel path, whereby a paint film of the enamel paint having a specified thickness is formed on the surface of the flat copper wire stock 23B.

After being applied with the paint film of the enamel paint having a specified thickness by the paint applicator 15, the flat copper wire stock 23B traveling along the travel path is baked with heat in the baking furnace 17, thereby forming the coating. As shown in FIG. 1, the enamel paint application by the paint applicator 15 and the coating formation in the baking furnace 17 are repeatedly carried out. Consequently, a flat enameled copper wire 25 is produced with a specified coating thickness. The flat enameled copper wire 25 is wound onto the spooler 19. As shown in FIG. 1, a direction in which the conductor 23 travels in the paint applicator 15 and the baking furnace 17 is referred to as a traveling direction TD. A direction opposite to the traveling direction TD is referred to as an upstream direction UD.

The method for forming the coating comprises, for example, steps as follows: applying the enamel paint on the surface of the flat copper wire stock 23B, the enamel paint being a paint containing, for example, a resin and a solvent; and curing the resin in the enamel paint by evaporating the solvent in the enamel paint applied on the surface of the flat copper wire stock 23B. Upon evaporation of the solvent and cure of the resin, the flat enameled copper wire 25 is formed.

### 2. Configurations of Paint Applicator 15 and Baking Furnace 17

### (2-1) Overall Configurations of Paint Applicator 15 and Baking Furnace 17

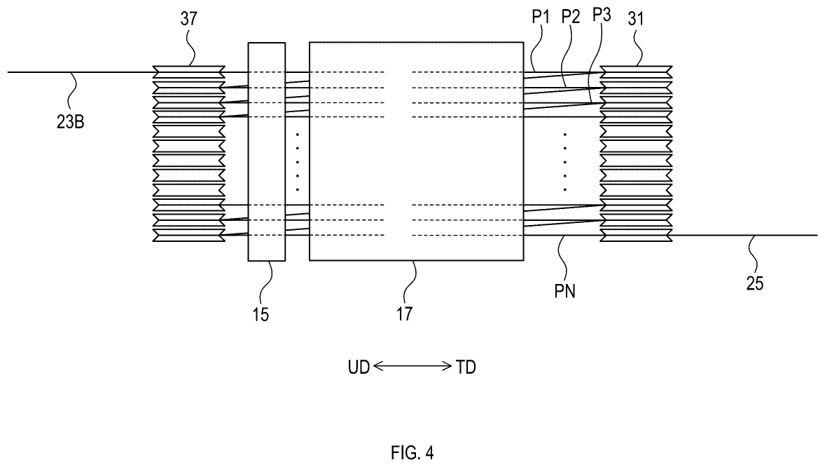

Descriptions will be given of overall configurations of the paint applicator 15 and the baking furnace 17 with reference to FIGS. 1 and 4. The flat copper wire stock 23B fist passes through the paint applicator 15 and the baking furnace 17, and then rollers 31, 33, 35, 37 change the traveling direction of the flat copper wire stock 23B. Thus, the flat copper wire stock 23B returns to a position in the upstream direction UD with respect to the paint applicator 15 and again passes through the paint applicator 15 and the baking furnace 17. By repeatedly going through a sequence of these steps, the flat copper wire stock 23B passes through the paint applicator 15 and the baking furnace 17 N times. N is a natural number greater than or equal to 2.

A travel path of the flat copper wire stock 23B passing through the paint applicator 15 and the baking furnace 17 for the i-time is referred to as an i-th path Pi, wherein “i” is a natural number greater than or equal to 1 and less than or equal to N. For example, travel paths of the flat copper wire stock 23B passing through the paint applicator 15 and the baking furnace 17 for the first time, the second time, and the third time are the first path P1, the second path P2, and the third path P3, respectively. As shown in FIG. 4, a position of the j-th path Pj in the horizontal direction is shifted relative to the (j-1)-th pass P(j-1) in a certain direction, wherein “j” is any natural number greater than or equal to 2 and less than or equal to N.

### (2-2) Configuration of First Path P1

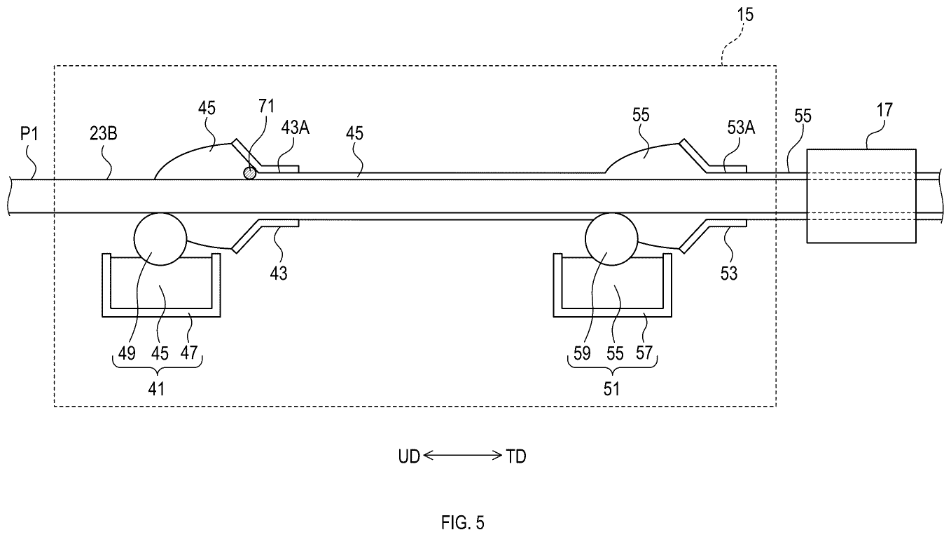

The flat copper wire stock 23B traveling the first path P1 is shown in FIG. 5. The paint applicator 15 comprises a first paint applicator 41 and a first die 43 corresponding to the flat copper wire stock 23B traveling the first path P1.

The first paint applicator 41 applies a first paint 45 on the surface of the flat copper wire stock 23B traveling the first path P1. The first paint 45 is an enamel paint. The first paint applicator 41 comprises: a first paint tank 47; the first paint 45; and a roll coater 49. The first paint tank 47 contains the first paint 45. The roll coater 49 is in contact with both the first paint 45 contained in the first paint tank 47 and the surface of the flat copper wire stock 23B. As the roll coater 49 rotates, the first paint 45 is applied on the surface of the flat copper wire stock 23B.

The first die 43 has a tubular shape. The first die 43 includes a hole 43A that allows the flat copper wire stock 23B to pass. An axial direction of the hole 43A is parallel to a longitudinal direction of the flat copper wire stock 23B. At least on the upstream direction UD side, the hole 43A increases in size toward the upstream direction UD. On the traveling direction TD side, the hole 43A has constant shape and size. In an area where the shape and size of the hole 43A are constant, the shape of the hole 43A is similar to the cross-sectional shape of the flat copper wire stock 23B, and the size of the hole 43A is slightly larger than the size of the flat copper wire stock 23B.

The first die 43 is arranged on the traveling direction TD side relative to the first paint applicator 41. The flat copper wire stock 23B with the first paint 45 applied by the first paint applicator 41 passes through the first die 43. When the flat copper wire stock 23B passes through the first die 43, a part of the first paint 45 attached to the surface of the flat copper wire stock 23B on an outer peripheral side than the hole 43A is removed. Because of this, a thickness of the paint film of the first paint 45 attached to the surface of the flat copper wire stock 23B having passed through the first die 43 is uniform. The first paint 45 removed from the flat copper wire stock 23B by the first die 43 returns to the first paint tank 47.

The paint applicator 15 comprises a second paint applicator 51 and a second die 53 corresponding to the flat copper wire stock 23B traveling the first path P1. The second paint applicator 51 and the second die 53 are located on the traveling direction TD side relative to the first die 43.

The second paint applicator 51 applies a second paint 55 on the surface of the flat copper wire stock 23B traveling the first path P1. When the second paint applicator 51 applies the second paint 55, the first paint 45 applied by the first paint applicator 41 is still uncured. The second paint applicator 51 comprises: a second paint tank 57; the second paint 55; and a roll coater 59. The second paint tank 57 contains the second paint 55. The second paint tank 57 is separated from the first paint tank 47. Thus, the first paint 45 unlikely mixes into the second paint tank 57.

The roll coater 59 is in contact with both the second paint 55 contained in the second paint tank 57 and the surface of the flat copper wire stock 23B. As the roll coater 59 rolls, the second paint 55 is applied on the surface of the flat copper wire stock 23B. The second paint 55 has the same composition as the first paint 45. The flat copper wire stock 23B after passing through the first die 43 and before reaching the second paint applicator 51 does not come in contact with the rollers, pulleys, etc. The flat copper wire stock 23B being between the first die 43 and the second die 53 forms a straight line. Thus, it is possible to maintain a more uniform thickness of the paint film of the first paint 45.

The second die 53 has a tubular shape. The second die 53 has a hole 53A that allows the flat copper wire stock 23B to pass. An axial direction of the hole 53A is parallel to the longitudinal direction of the flat copper wire stock 23B. At least on the upstream direction UD side, the hole 53A increases in size toward the upstream direction UD. On the traveling direction TD side, the hole 53A has constant shape and size. In an area where the shape and size of the hole 53A are constant, the shape of the hole 53A is similar to the cross-sectional shape of the flat copper wire stock 23B, and the size of the hole 53A is slightly larger than the size of the flat copper wire stock 23B.

The second die 53 is arranged on the traveling direction TD side relative to the second paint applicator 51. The flat copper wire stock 23B with the second paint 55 applied by the second paint applicator 51 passes through the second die 53. When the flat copper wire stock 23B passes through the second die 53, a part of the second paint 55 attached to the surface of the flat copper wire stock 23B on an outer peripheral side than the hole 53A is removed. Because of this, a thickness of the paint film of the second paint 55 attached to the surface of the flat copper wire stock 23B having passed through the second die 53 is uniform. The second paint 55 removed from the flat copper wire stock 23B by the second die 53 returns to the second paint tank 57.

The flat copper wire stock 23B having passed through the second die 53 travels forward to the baking furnace 17. In the baking furnace 17, the flat copper wire stock 23B undergoes a baking process. During the baking process, the second paint 55 is cured. A paint gap at the first die 43 is referred to as a first paint gap. A paint gap at the second die 53 is referred to as a second paint gap. For example, the first paint gap is smaller than the second paint gap.

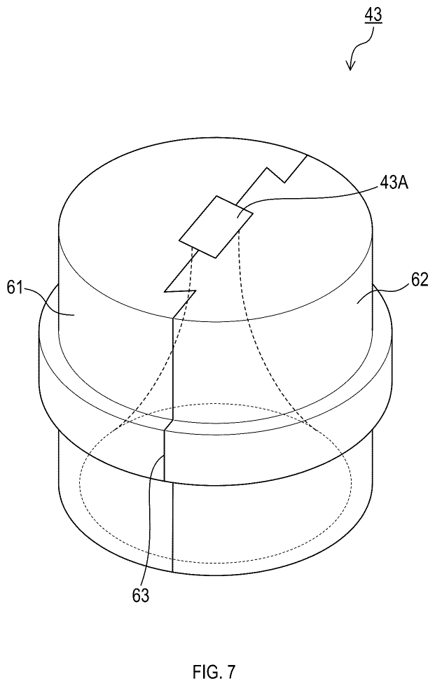

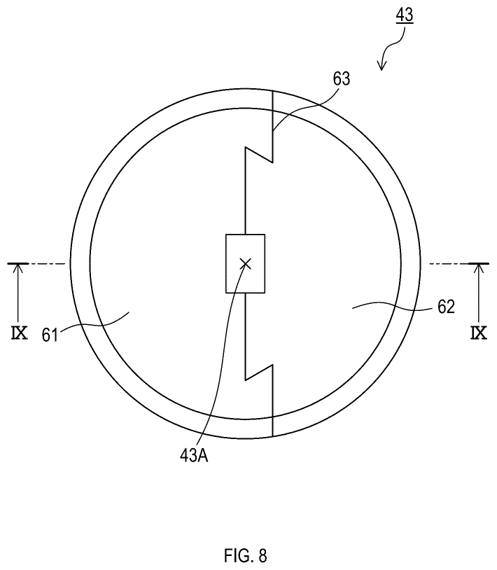

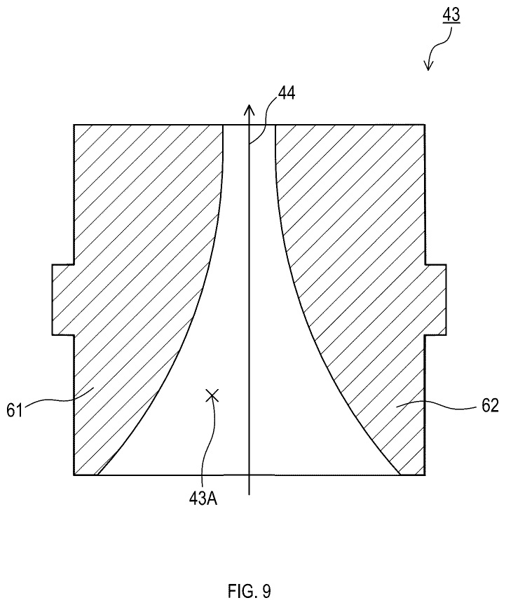

The first die 43 has, for example, a configuration shown in FIGS. 7 to 9. The first die 43 is dividable into a first part 61 and a second part 62 at a dividing surface 63. The dividing surface 63 is a surface that passes through the hole 43A and is along an axial direction 44 of the hole 43A. A dividable die disclosed in, for example, Japanese Unexamined Patent Application Publication No. 2013-161675, can be used as the dividable first die 43.

(2-3) Configuration of j-th Path Pj

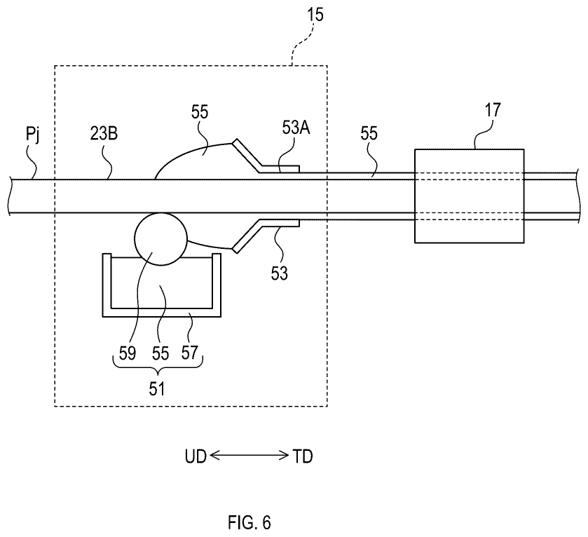

The flat copper wire stock 23B traveling the j-th path Pj is shown in FIG. 6, wherein “j” is any natural number greater than or equal to 2 and less than or equal to N. The paint applicator 15 does not comprise the first paint applicator 41 and the first die 43 for the flat copper wire stock 23B traveling the j-th path Pj, for example.

The paint applicator 15 comprises the second paint applicator 51 and the second die 53 corresponding to the flat copper wire stock 23B traveling the j-th path Pj. The second paint applicator 51 and the second die 53 have similar configurations and similar functions to ones corresponding to the flat copper wire stock 23B traveling the first path P1. For example, the second paint applicators 51 corresponding to the first path P1 through an N-th path PN share a single second paint tank 57.

### 3. Effects of Production Apparatus 1 and Method For Producing

(1A) In a case where a foreign matter 71 is attached to the surface of the flat copper wire stock 23B, as shown in FIG. 5, the foreign matter 71 is captured by the first die 43. This makes it possible to reduce the foreign matter 71 caught in the second die 53. Consequently, it is possible to suppress occurrence of an abnormality in appearance of the flat enameled copper wire 25.

Due to the foreign matter 71 captured by the first die 43, there is a case where the thickness of the paint film of the first paint 45 on the flat copper wire stock 23B having passed through the first die 43 is non-uniform. However, even in such a case, the thickness of the paint film becomes uniform as the second paint applicator 51 applies the second paint 55 while the first paint 45 is uncured. This makes it possible to suppress occurrence of an abnormality in appearance of the flat enameled copper wire 25.
(1B) For example, the first paint gap is smaller than the second paint gap. In such a case, the first die 43 can further securely capture the foreign matter 71.
(1C) For example, the first die 43 is dividable into the first part 61 and the second part 62. The first die 43 being divided into the two parts makes it possible to easily remove the foreign matter 71 captured therein.
(1D) In the travel path of the flat copper wire stock 23B, a section in which the flat copper wire stock 23B passes through each of the second paint applicator 51, the second die 53, and the baking furnace 17 once is referred to as a section A. The first path P1 consists of: a section in which the flat copper wire stock 23B passes through each of the first paint applicator 41 and the first die 43 once; and the section A. Each path from the second path P2 to the N-th path PN consists only of the section A. Accordingly, after passing through the first paint applicator 41 and the first die 43, the flat copper wire stock 23B passes through the section A N times.

This makes it possible to minimize the number of times that the flat copper wire stock 23B passes through the first paint applicator 41 and the first die 43, and thus the configuration of the production apparatus 1 can be simplified, and the time required to carry out the method can be reduced.

(1E) For example, the first paint tank 47 containing the first paint 45 is separated from the second paint tank 57 containing the second paint 55. In such a case, it is possible to suppress entrance of the first paint 45 including the foreign matter 71 into the second paint tank 57.

### Other Embodiments

The above has described the embodiment according to the present disclosure. However, the present disclosure is not limited to the aforementioned embodiment and may be embodied in various forms.
(1) In the first embodiment, the production apparatus 1 comprises one first paint applicator 41 and one first die 43. The production apparatus 1 may comprise a plurality of units, each of which comprises one first paint applicator 41 and one first die 43. The plurality of units are arranged along the travel path of the flat copper wire stock 23B. For example, in a case where the production apparatus 1 comprises three units, the flat copper wire stock 23B passes through the first paint applicator 41, the first die 43, the first paint applicator 41, the first die 43, the first paint applicator 41, and the first die 43 in this order. In this case, the first dies 43 can further securely capture the foreign matter 71.
(2) The paint applicator 15 may also comprise the first paint applicator 41 and the first die 43 for the flat copper wire stock 23B traveling the j-th path Pj, wherein “j” is any natural number greater than or equal to 2 and less than or equal to N.
(3) The first paint gap and the second paint gap may have the same size. The first paint gap may be larger than the second paint gap.
(4) The first die 43 may be an integral type that is not dividable.
(5) the production apparatus 1 may produce an enameled copper wire besides the flat enameled copper wire and may produce, for example, a rounded enameled copper wire.
(6) One function of one component in the above-described embodiment may be realized by a plurality of components, and a plurality of functions of a plurality of components may be realized by one component. Part of the configuration in the above-described embodiment may be omitted. At least part of the configuration in the above-described embodiment may be added to any of other configurations in the above-described embodiments or replace part of any of the other configurations.
(7) In addition to the production apparatus for producing an enameled copper wire, the present disclosure can be achieved in various forms including: a system comprising the production apparatus as its component; a method for removing a foreign matter; and a foreign matter removal device.

### Technical Ideas Disclosed Herein

### Item 1

A production apparatus for producing an enameled copper wire, the production apparatus comprising:
a first paint applicator configured to apply a first paint on a surface of a conductor traveling along a travel path;
a first die configured to allow the conductor with the first paint applied by the first paint applicator to pass therethrough;
a second paint applicator configured to apply a second paint on the surface of the conductor, the conductor having passed through the first die and having the first paint thereon uncured;
a second die configured to allow the conductor with the second paint applied by the second paint applicator to pass therethrough; and a baking section configured to bake the conductor having passed through the second die.

### Item 2

The production apparatus for producing an enameled copper wire according to Item 1,
wherein a gap between an inner surface of the first die and the conductor is smaller than a gap between an inner surface of the second die and the conductor.

### Item 3

The production apparatus for producing an enameled copper wire according to Item 1 or 2,
wherein there are a plurality of units arranged along the travel path, each of the units comprising the first paint applicator and the first die.

### Item 4

The production apparatus for producing an enameled copper wire according to any one of Items 1 to 3,
wherein the first die is configured to be dividable at a dividing surface that passes through a hole allowing the conductor to pass and that extends along an axial direction of the hole.

### Item 5

The production apparatus for producing an enameled copper wire according to any one of Items 1 to 4,
wherein the production apparatus is configured such that the conductor passes through the first paint applicator and the first die and then passes through a section including the second paint applicator, the second die, and the baking section two or more times.

### Item 6

The production apparatus for producing an enameled copper wire according to any one of Items 1 to 5,
wherein a first paint tank for containing the first paint is separated from a second paint tank for containing the second paint.

### Item 7

A method for producing an enameled copper wire, the method comprising the steps of:
applying a first paint on a surface of a conductor traveling along a travel path;
allowing the conductor applied with the first paint to pass through a first die;
applying a second paint on the surface of the conductor, the conductor having passed through the first die and having the first paint thereon uncured;
allowing the conductor applied with the second paint to pass through a second die; and
baking the conductor having passed through the second die.

What is claimed is:

1. A production apparatus for producing an enameled copper wire, the production apparatus comprising:
a first paint applicator configured to apply a first paint on a surface of a conductor traveling along a travel path;
a first die configured to allow the conductor with the first paint applied by the first paint applicator to pass therethrough;
a second paint applicator configured to apply a second paint on the surface of the conductor, the conductor having passed through the first die and having the first paint thereon uncured;
a second die configured to allow the conductor with the second paint applied by the second paint applicator to pass therethrough; and
a baking section configured to bake the conductor having passed through the second die.

2. The production apparatus for producing an enameled copper wire according to claim 1,
wherein a gap between an inner surface of the first die and the conductor is smaller than a gap between an inner surface of the second die and the conductor.

3. The production apparatus for producing an enameled copper wire according to claim 1,
wherein there are a plurality of units arranged along the travel path, each of the units comprising the first paint applicator and the first die.

4. The production apparatus for producing an enameled copper wire according to claim 1,
wherein the first die is configured to be dividable at a dividing surface that passes through a hole allowing the conductor to pass and that extends along an axial direction of the hole.

5. The production apparatus for producing an enameled copper wire according to claim 1,
wherein the production apparatus is configured such that the conductor passes through the first paint applicator and the first die and then passes through a section including the second paint applicator, the second die, and the baking section two or more times.

6. The production apparatus for producing an enameled copper wire according to claim 1,
wherein a first paint tank for containing the first paint is separated from a second paint tank for containing the second paint.

7. A method for producing an enameled copper wire, the method comprising the steps of:
applying a first paint on a surface of a conductor traveling along a travel path;
allowing the conductor applied with the first paint to pass through a first die;
applying a second paint on the surface of the conductor, the conductor having passed through the first die and having the first paint thereon uncured;
allowing the conductor applied with the second paint to pass through a second die; and
baking the conductor having passed through the second die.
